(19) United States
(12) Patent Application Publication
(10) Pub. No.: US 2009/0307370 A1
(43) Pub. Date: Dec. 10, 2009

(54) METHODS AND SYSTEMS FOR DATA TRANSFER AND NOTIFICATION MECHANISMS

(75) Inventors: Marco BOERRIES, Los Altos Hills, CA (US); Matthias Breuer, Seevetal (DE); Markus Meyer, Winsen Luhe (DE); Torsten Schulz, Pinneberg (DE); Venkatachary Srinivasan, Sunnyvale, CA (US); Bernhard Wellhofer, Hamburg (DE)

Correspondence Address: YAHOO C/O MOFO PALO ALTO, 755 PAGE MILL ROAD, PALO ALTO, CA, 94304, US

(73) Assignee: YAHOO! INC, Sunnyvale, CA (US)

(21) Appl. No.: 12/543,231

(22) Filed: Aug. 18, 2009

Related U.S. Application Data
(62) Division of application No. 11/182,614, filed on Jul. 14, 2005.

(51) Int. Cl. G06F 15/16

(52) U.S. Cl. 709/232; 709/206

(57) ABSTRACT

In one aspect a device such as a mobile device includes logic operable to display an email message received from a remote location, the email message having associated data (e.g., an attachment) located remotely to the device (e.g., with a server or the like). The system further includes logic operable to receive a request for the associated data, and initiate an asynchronous fetch of the associated data, wherein the associated data is fetched in the background of the device. The system may further include logic operable to initiate a notification after receiving the request for the data that the associated data will be fetched, and/or initiate a notification that the associated data has been fetched. The associated data may include an attachment, media object, or other data associated with the email message.

### RELATED APPLICATIONS

This application is a divisional application of U.S. application Ser. No. 11/182,614, filed Jul. 14, 2005, entitled METHODS AND SYSTEMS FOR DATA TRANSFER AND NOTIFICATION MECHANISMS, to Marco BOERRIES et al.; which is related to the following co-pending patent applications: U.S. application Ser. No. 11/182,287, filed Jul. 14, 2005, entitled CONTENT ROUTER, to Torsten SCHULZ et al.; U.S. application Ser. No. 11/182,313, filed Jul. 14, 2005, entitled CONTENT ROUTER ASYNCHRONOUS EXCHANGE, to Marco BOERRIES et al.; U.S. application Ser. No. 11/182,665, filed Jul. 14, 2005, entitled CONTENT ROUTER REPOSITORY, to Bjørn EBBESEN et al.; U.S. application Ser. No. 11/182,331, filed Jul. 14, 2005, entitled CONTENT ROUTER FORWARDING, to Venkatachary SRINIVASAN et al.; U.S. application Ser. No. 11/182,288, filed Jul. 14, 2005, entitled CONTENT ROUTER NOTIFICATION, to Matthias BREUER et al.; U.S. application Ser. No. 11/183,073, filed Jul. 14, 2005, entitled CONTENT ROUTER GATEWAY, to Meher TENDJOUKIAN et al.; U.S. application Ser. No. 11/182,348, filed Jul. 14, 2005, entitled SYSTEM AND METHOD FOR SERVICING A USER DEVICE, to Matthias Breuer et al.; and U.S. application Ser. No. 11/182,664, filed Jul. 14, 2005, entitled UNIVERSAL CALENDAR EVENT HANDLING, to Meher Tendjoukian et al., all of which are hereby incorporated by reference in their entirety.

### BACKGROUND

1. Field

This relates generally to the transfer of data, and in one aspect, to schedule and notification mechanisms associated with the arrival of data segments, such as email messages and associated attachments, which may improve device performance.

2. Description of Related Art

A variety of mobile computing devices exist, such as personal digital assistants (PDAs), mobile phones, smart phones, camera phones, pocket personal computers, and the like which perform an ever growing variety of functions. The trend is for mobile computing devices to have increased functionality such that a single mobile device may, for example, provide Internet access, maintain a personal calendar, provide mobile telephony, take digital photographs, play music files, and the like. Memory size and system resources, however, are typically limited on mobile devices and may become increasingly scarce as the functionality of such mobile devices expands.

Various user mobile devices such as PDAs, mobile phones, smart phones, camera phones, pocket personal computers, etc., are capable of receiving and viewing email messages. Such user devices generally include less capability (e.g., memory and/or processing power) than a stand alone computer or personal computer for receiving and processing emails. Accordingly, such user mobile devices are typically capable to process and store a large number of text based email messages that generally have relatively small data sizes (e.g., on the order of a few kilobytes), but are not particularly well suited for processing or storing large data files or attachments, such as media objects (including still images, moving images, audio files, documents, and the like, and the like).

For example, some mobile devices operate to fetch all data associated with an email before delivering the email to the device. If the email and attachment have a large file size, for example, the email may not be viewable on the device until the entire attachment has been transferred to the device. In such systems, however, the device memory may be insufficient to store the attachment (or at least insufficient to store a large number of emails having attachments). Additionally, the processing power or resources of the device may be unacceptably depleted during the transfer of the attachment to the device, leading to undesirable delays and waiting periods in which the user is unable to use other functions of the device.

FIG. 1 schematically illustrates an example where an email and associated attachment are retrieved and delivered to a mobile device in a synchronous manner. For example, a user requests an email from one or more emails listed on a device, e.g., a mobile device, cell phone, or the like. The device fetches data associated with the email message and attachment from a data source, which may include a mobile network, email server, device, data storage, or the like, and delivers the email message and attachment to the device in a synchronous manner.

The downloading process may take several seconds to several minutes or more depending, for example, on the particular attachment file size, data transfer rate, and status of the data source. During the transfer process, however, the system resources of the device are typically consumed by the transfer of the email message and attachment data. During this time, the user may be prevented or constrained from accessing other data stored with the device or performing other functions with the device such as accessing other email messages, calendars, placing calls, etc., and must wait for the transfer process to be completed.

Additionally, in some devices a user has to intermittently check on the status of the download until the data has been retrieved. For example, a user may have to repeatedly check a status bar or try to access the data until successful. This may frustrate a user, particularly if the user must navigate through different screens or interfaces to access the status of the download.

### SUMMARY

According to one aspect provided here, systems and methods for transferring data to a device are provided. In one example a device includes logic operable to display an email message received from a remote location, the email message having associated data (e.g., an attachment) located remotely to the device (e.g., with a server or the like). The system further includes logic operable to receive a request for the associated data, and initiate a fetch of the associated data, wherein the associated data is fetched in the background of the device (e.g., without interaction with the user and while the user may access other applications or tasks). In one example, the fetch of the associated data is asynchronous.

The system may further comprise logic operable to initiate a notification after receiving the request for the data that the associated data will be fetched, and/or initiate a notification after the associated data has been fetched that the associated data has been fetched and is available. The associated data may include an attachment, media object, or other data segments associated with the email message such as a Hypertext Markup Language (HTML), Rich Text Format (RTF), or Word document version of the email message. In one example, the system comprises a mobile device, capable of wireless communication with one or more networks.

According to another aspect and example, a device is provided that includes a memory, a display, a communication interface, and a processor. The device includes logic operable to receive a data segment from a remote location, the data segment associated with additional data located remotely, receive a request for the additional data, and initiate a fetch of the additional data, wherein the additional data is fetched in the background of the device. The device may further be operable to initiate a notification that the additional data has been received.

According to another aspect and example, a system for coordinating the transfer of data to a device is provided. The system may include logic operable to parse a data set into at least a first data segment and second data segment, and initiate a transfer of the first data segment to a remote device, the first data segment associated with the second data segment. The system may further receive a request for the second data segment from the remote device, and initiate a transfer of the second data segment to the remote device. The second data set may be fetched by the remote device asynchronously. The first data segment may include at least a portion of an email message and the second data segment may include an attachment, for example, a media object. In one example, the system may further transcode the first and/or second data segment for delivery to the device. For instance, a server may transcode the data based on device configurations or the request from the device.

According to another aspect and example, a method for handling data transfers is provided. In one example, the method includes displaying at least a portion of an email message on a device, the email message having data associated therewith located remote from the device, receiving a request for the data, and initiating a fetch of the data from the remote location, wherein the data is fetched in the background of the device. The method may further include initiating a notification that the associated data will be fetched after receiving the request for the data, and/or initiating a notification that the associated data has been fetched after initiating the fetch of the associated data. Further, the fetch of the associated data may be asynchronous.

According to another aspect and example, a computer program product comprising program code associated with transferring data and issuing notifications associated with a data transfer is provided. In one example, the computer program product includes program code operable to display an email message received from a remote location, the email message having associated data located remotely, program code operable to receive a request for the associated data, and program code operable to initiate a fetch of the associated data, wherein the associated data is fetched in the background. Additionally, code may be included to initiate a notification that the associated data will be fetched subsequent to receiving the request for the data, and/or initiate a notification that the associated data has been fetched subsequent to initiating the fetch of the associated data.

The present invention and its various aspects are better understood upon consideration of the detailed description below in conjunction with the accompanying drawings and claims.

### BRIEF DESCRIPTION OF THE DRAWINGS

FIG. 1 illustrates a related art system and method for requesting data from a data source.

FIG. 2 illustrates an overview of an exemplary environment in which some of the aspects described here may be used.

FIG. 3A illustrates an exemplary method for asynchronously delivering an email message attachment according to one example.

FIGS. 3B-3D illustrate exemplary display screens associated with a device.

FIG. 4 illustrates a system and method for requesting and fetching data according to one example.

FIG. 5 illustrates another system and method for requesting data and issuing a notification of the data arrival according to one example.

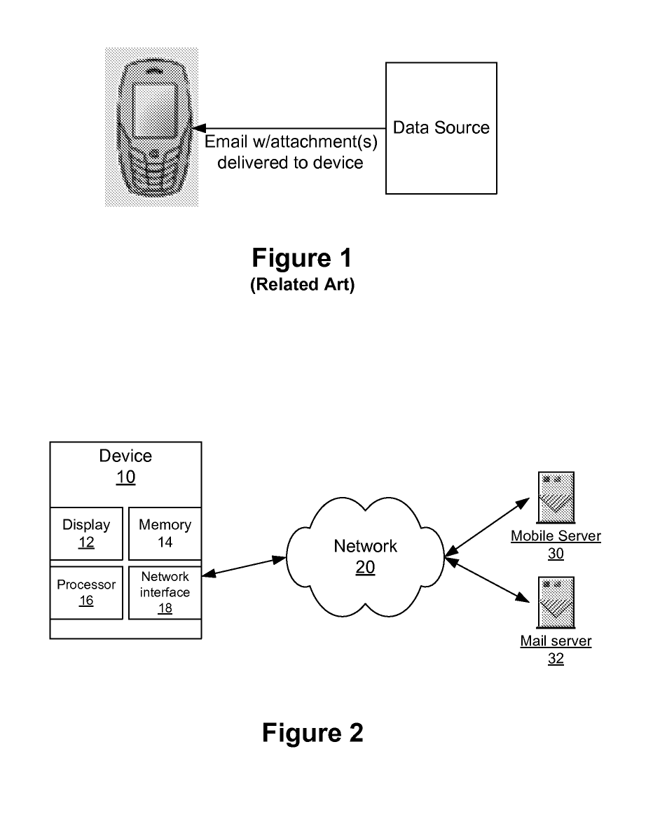

### DETAILED DESCRIPTION

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described herein and shown, but is to be accorded the scope consistent with the claims.

Some examples described herein provide systems and methods for delivering data to a device in the background of the device, thereby avoiding delays common with conventional mobile or other limited processing power devices when receiving data. Additionally, examples described herein include a notification mechanism associated with the delivery of the data to the device, thereby alleviating the user from having to check the device for data arrival.

In one example, a router or server may filter, parse, or otherwise reduce the size of a data set including, e.g., an email message and attachment for delivery to a device. In one example, the data set is divided into at least a first segment including the email header and body for delivery to the device, and a second segment including the attachment. The user may view the first segment, e.g., including the email message, and thereafter request the second data segment, e.g., an attachment associated therewith. The device fetches the second data segment in the background, thereby allowing the user relatively uninterrupted access to other applications and functions of the device during the transfer. In one example, the second data segment is fetched asynchronously.

In another example, the device further issues one or more notifications associated with the data arrival events. For example, the device may initiate a notification after the transfer of the second data segment to the device that the second data segment (e.g., an email attachment) has been delivered to the device and is available. A notification associated with the delivery of the additional data, especially for transfers that may take a considerable amount of time, may alleviate a user from the burden of checking on the progress or completion of a transfer (whether or not the user has access and the ability to use other functions of the device). In particular, the notification generally obviates the need for a user to check the progress of the download via a dialog box or navigate multiple screens/interfaces to inquire on the status of a download and may rely on the notification.

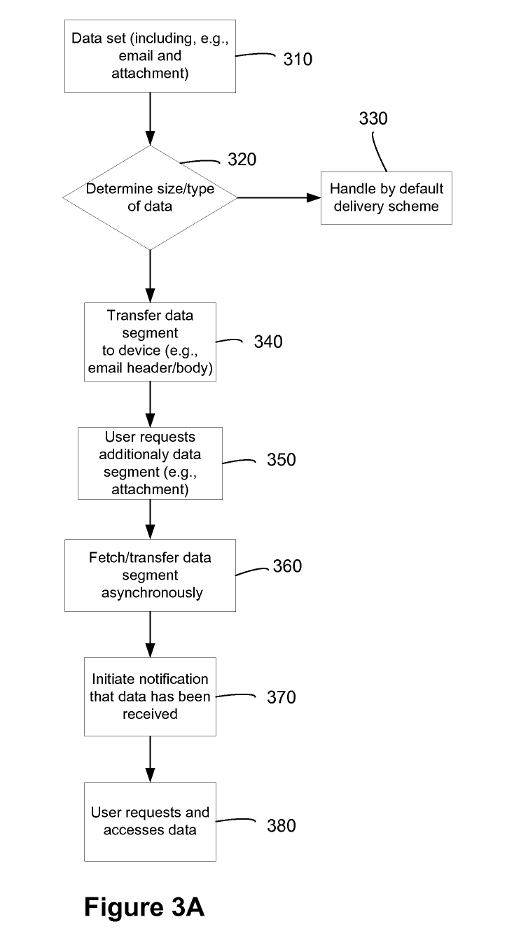

FIG. 2 illustrates an overview of an exemplary environment in which some aspects described here may be used. Not all the components may be required, and variations in the arrangement and type of the components may be made without departing from the spirit and scope of the inventions.

Broadly speaking, a device 10 communicates with a network 20 and one or more servers, e.g., a mobile server 30 and an email server 32. Device 10 may communicate via a wireless network, such as a wireless gateway, e.g., a cellular, satellite, or other wireless network. Additionally, device 10 may communicate via a non-wireless network such as a cable or fiber optic network, or a combination of wireless and non-wireless systems.

Device 10 may include various devices including, for example, mobile devices such as a PDA, mobile telephone, smart phone, pager, walkie talkie, radio frequency (RF) device, infrared (IR) device, Wi-Fi device, pocket personal computer, tablet personal computer, laptop computer, and integrated devices combining one or more of the preceding devices, as well as a desktop computer, or the like. Device 10 may include a processor 16 connected to an input device such as a keyboard (not shown), a network interface 18, a memory 14, and a display 12. The memory 14 may include logic or software operable with device 10 to perform some of the functions described herein. Device 10 may be operable to include a suitable interface for a messaging facility, such as an email inbox, instant messaging (IM), short messaging service (SMS), multimedia messaging service (MMS), and the like. Device 10 may further be operable to display a web browser for accessing the Internet, including webmail environments such as a Yahoo!® mail account or Hotmail® account, for example.

In one example, device 10 establishes a data connection with mobile server 30 and mail server 32 through network 20 such that the two devices can communicate. Through this data connection, device 10 is capable of retrieving and/or viewing email messages and associated data received in the user's email account. In addition to retrieving and/or viewing email messages, device 10 may communicate through network 20 to access other data such as media objects or the like stored with an online storage account.

By way of example only, a user can access and retrieve emails from various electronic mail accounts, using the wireless application protocol (WAP) feature or other data communication protocol of device 10. One of ordinary skill in the art will recognize that the Wireless Application Protocol (WAP) is only one way in which a wireless device can access data on a network and that any such data transfer technology may be used to access and transfer electronic data. Further, the methods and systems described here are not limited to wireless communication methods and/or devices.

Network 20 may be in communication with or include one or more server and database systems in communication with one another and capable of wirelessly communicating with devices of a plurality of users. Exemplary server systems may include a mobile server, email sever, web server, voice messaging server, and the like. Further, network 20 may include a wireless network and one or more local area networks (LANs) and/or wide area networks (WAN), such as the Internet, that enables communication between various users, devices, servers, agents, modules, clients, processes, and the like.

Network 20 includes suitable circuitry for connecting servers 30 and 32 to network 20, and is constructed for use with various communication protocols including, but not limited to, TCP/IP, UDP/IP, SMS, IM, and WAP. Network 20 may include or interface with circuitry and components for communicating information, such as email messages, media objects, graphical displays, advertiser data, and the like, over a wired and/or wireless communications medium. Further, network 20 may include or be associated with an SMS center and/or MMS center for transferring files.

Additionally, in one example, a router is associated with network 20 and/or one or more servers, e.g., server 30 and 32, and operates to process email messages and associated attachments for delivery to device 10. For example, the router may filter data sets and parse out data segments e.g., separate email messages and attachments according to the examples described here for separate delivery to device 10. Additionally, the router may store segments not initially sent to device 10 in a repository (e.g., memory) for later delivery to device 10 and/or delivery to additionally devices.

It should be noted that although the exemplary methods and systems described herein describe use of separate servers and databases for performing the various functions, other embodiments could be implemented by storing the software or programming that operates described functions on a single server or any combination of multiple servers as a matter of design choice so long as the functionality described herein is performed. Although not depicted in the figures, the server systems 30 and 32 generally include such art recognized components as are ordinarily found in server systems, including but not limited to processors, RAM, ROM, clocks, hardware drivers, associated storage, and the like.

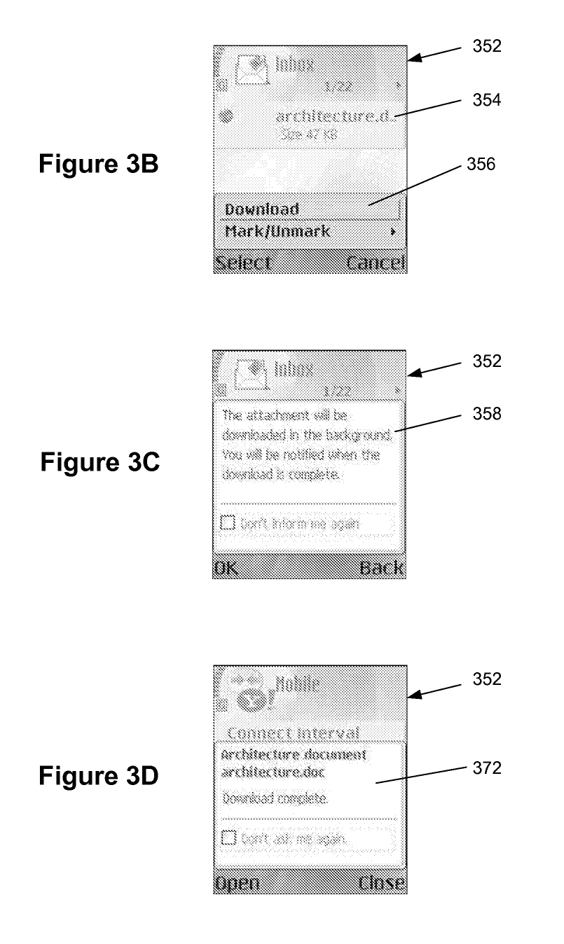

FIG. 3A illustrates an exemplary method for parsing and delivering one or more data segments to a device according to one example. The example is described generally as including a data set comprising an email message and an attachment (or other data set) associated with the email message, but should not be so limited. In one example, a device may receive an ASCII version of an email message by default (or other simple version), with the option of requesting and receiving an HTML, RTF or other version of the email if available. In another example, a first data segment may be part of a media object (whether associated with an email message or not), and the additional data may include further portions of or the entire media object.

The exemplary method begins at 310, where a data set including an email message and attachment for delivery to a device are received. The email message and attachment may be received by a server, such an email or mobile server, a network router, wireless gateway, or the like. It should be noted that the email may be addressed directly to a device or may have been redirected by a program running, for example, on a network or computer system operable to redirect or “push” the email messages to one or more devices, or addressed to an email account accessible by a device, e.g., an online email account, a storage account, device, or the like.

One or more characteristics of the data set (e.g., the data size of type of email message and/or associated attachment) are determined in block 320 to determine if the transfer should be handled by a default delivery scheme at block 330 or parsed and delivered as separate data segments as described for blocks 340-370. In one example, the determination is made based on the size of the attachment, e.g., if the attachment is greater than a predetermined value (e.g., greater than 1 megabyte) the attachment will be handled asynchronously as described herein and if less than the predetermined value, the attachment will be handled by the default scheme, e.g., delivered synchronously with the email message. Various threshold data sizes may be used, and may vary for different file types as well.

In another example, the determination may be made based upon metadata associated with the data set, and in particular, the attachment. For example, certain document types such as Microsoft® Power Point files or image files might always be handled asynchronously, whereas other document types such as Microsoft® Word files might always be delivered via the default delivery scheme. Additionally, a combination of using file size and file type may be used such that in the immediately previous example, Word files greater than a certain data size and all Power Point files and image files are handled asynchronously. Various other criteria and schemes are possible and contemplated.

In one example, the data set (including the email message and associated data) is parsed into two or more data segments, e.g., a first data segment including the email header and body, and a second segment including an attachment (such as a media object including, e.g., a still image, moving image, audio file, voice message file, documents, or the like).

A first segment of the data set, e.g., the email header and body, is transferred to the device at block 340. The first data segment may include a reduced data size email or the complete email absent the attachment. In some examples, the attachment may also be parsed or reduced in size and delivered with the email message at this time as part of the first data segment.

The device may display the email message within a user interface, such as a conventional inbox, IM interface, SMS interface, or the like, for example, and a user may select the additional data or attachment at block 350. In particular, a user may select and open the email message to view the message in any suitable interface associated with the device. The email message may further include a link, reference, or other indication (e.g., an icon or text based indicator) that an attachment is associated with the email message. A user may select the reference or link, thereby requesting the attachment be fetched from the data source and delivered to the device.

FIG. 3B illustrates an exemplary display 352 showing an illustrative user interface according to one example. Display 352 includes an icon indicating that an attachment 354 is available for download. The icon further includes the file name and file size, but in other examples, more or less information associated with the additional data might be displayed. The user may select the download icon 356 to initiate a fetch of the attachment. In other examples, two or more attachments or data segments for download may be listed, with options for downloading some or all of the attachments or data segments. Additionally, a notification that the data will be retrieved and that a further notification will be displayed when the data arrives may be initiated and displayed on the device, e.g., in display 352, as shown in FIG. 3C.

The device receives the request for additional data when an attachment is selected by the user, and initiates a request operation to fetch additional data at block 360. In one example, the transfer or fetch of the additional data is performed in the background of the device such that other functions and/or applications of the device are accessible by the user. For example, the system resources are not entirely consumed by the transfer with a wait screen or icon, and without halting or delaying functionality of the device. In one example, the transfer includes an asynchronous fetch, but in some instances, the fetch of the data may include a direct download (not asynchronous) if the source of the additional data (e.g., through various servers etc.) is directly accessible to the device.

When the transfer is complete the user is notified by the device that the transfer of the additional data segment to the device is complete in box 370. The notification may be initiated by the device upon receiving the complete data segment or may be initiated by the data source of the transfer as the transfer is completed. FIG. 3D illustrates an exemplary notification 372 with display 352 to notify a user that the data has been fetched and is available. Further, the notification may include a second email message, an SMS message, or other suitable notification method compatible with the device.

It should be understood that the various blocks and functions described may be carried out on the device, the data source, or both. Further, various functions may be carried in other orders not shown, in parallel, or in series, and that certain functions may be omitted and additional functions may be included. The device may include suitable logic, e.g., any combination of software, firmware, or hardware, operable to control the transfer of the additional data in the background (e.g., performing the transfer asynchronously).

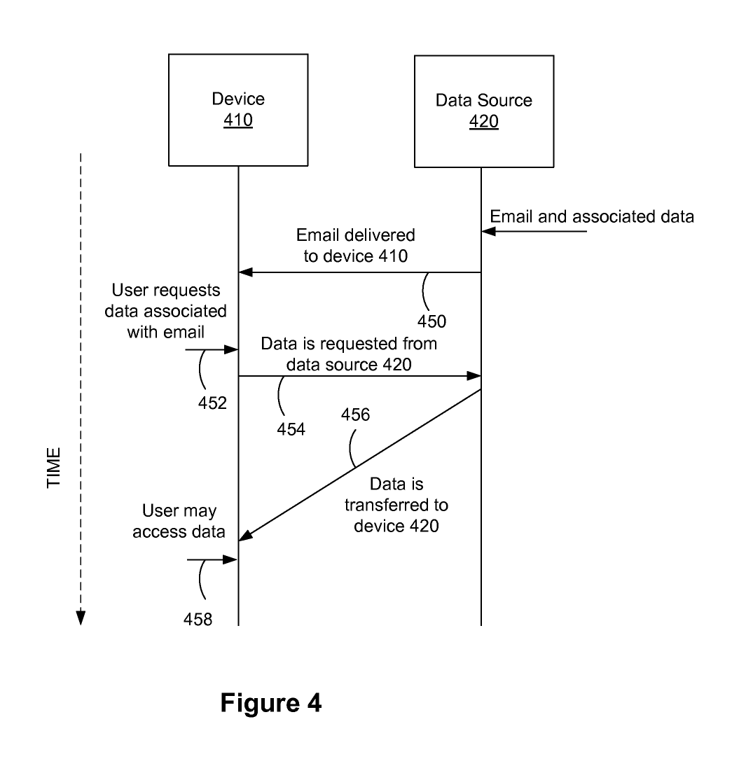

FIG. 4 illustrates exemplary communication and data flows between a device 410 and data source 420 over time according to one example. Device 410 may include any device as described, data source 420 may include any suitable data source 420 as described (such as network 20 and servers 30, 32 as described with respect to FIG. 2), and the communication between device 410 and data source 420 may take any suitable form as described. Additionally, device 410 and data source 420, alone or in combination, may include suitable logic to carry out the functions as described.

Initially, an email message is delivered to device 410 from data source 420 as shown by transfer 450. The delivery of the email may take many forms depending on the data size of the email and/or any associated objects (such as attachments, which may include references or embedded objects associated with the email). For example, the email may be parsed by data source 420, which may include a router, logic, program, or the like, which filters the email message of attachments and other objects and forwards only the email header and message to device 410. In other examples, a reduced size email (e.g., an ASCII version of an HTML or RTF email) and/or attachment may be forwarded to device 410. Various other schemes for sending a reduced data size email (with or without a reduced data size attachment) may be used. Data source 420 and device 410 may cooperate to transfer reduced sized emails for all emails or may include one or more criteria for parsing or reducing the size of an email on a selected basis.

In one example, data source 420 includes a content router, which may parse a data set (e.g., including an email message, an email message with an attachment, e.g., a media object, or other file(s)) based on the size and/or characteristics of the files into one or more data segments. Additionally, if device 410 does not support a particular application, such as a Power Point application, the content router may remove attachments including Power Point files prior to delivering to device 410. The file may be retained by data source 420 for delivery to other devices, which may receive such a file.

Additionally, in one example, the data may be transcoded based on characteristics of device 410. Data source 420, e.g., a server included therewith, may determine the capabilities or preferred characteristics of device 410 such as screen size, installed applications, or the like. Data can be transcoded by data source 420 prior to transferring to device 410. Transcoding may vary from transcoding the size and color depth or type of image files or more complex transcoding such as converting a Word document to a PDF document. Additionally, the transcoding may include reducing an image size or resolution of an image embedded in a word document or removing HTML features from documents.

In one example, data source 420 may include a server and gateway which stores the additional data associated with email message in a temporary storage location and indicate to the device where the additional data is available for download. For instance, an email message and attachment may reside with an email server, and the email message may be transferred to the device and the attachment transferred to a temporary storage location remote from the originating email server. The device may be alerted of the location of the attachment with the original email or upon receiving a request for the attachment.

Exemplary router systems and methods are described for example in copending U.S. application Ser. No. 11/182,287, filed Jul. 14, 2005, entitled CONTENT ROUTER, to Torsten SCHULZ et al., and incorporated by reference as if fully set forth herein.

At 452 a user requests data associated with the email message received, for example, an attachment associated with the email message. In one example, device 410 displays the email and includes an icon or other indication that an attachment or data object is associated with the email. The user may select to receive the attachment, for example, by selecting the icon or by any other suitable method associated with device 410.

In response to the user request at 452, the device 410 requests the additional data associated with the email message from data source 420 via request 454. Data source 420 and device 410 thereafter operate to asynchronously fetch the data at 456, whereby the data is fetched in the background of device 410. A user may continue to access and use functions of device 410 during transfer 456. Subsequent to the data being fetched via transfer 456, the user may access the data at 458.

These examples generally allow device 410 to receive and store a large number of emails or references to emails without unduly stressing the resources of device 410, in particular, the memory and processing power of device 410. For example, tens to thousands of emails or more might be stored on device 410. Additionally, the reduced size first data segment and asynchronous fetch of the second data segment generally allows for a user to quickly access emails and other applications without delivery of the full size data set consuming resources of device 410.

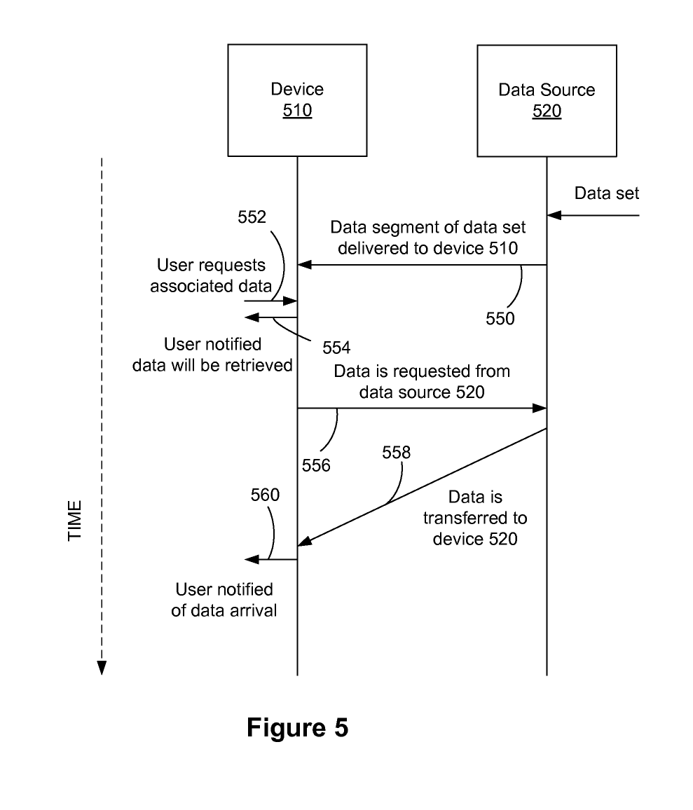

FIG. 5 illustrates another exemplary data flow between a device 510 and data source 510 for an exemplary system and method for transferring data and notifying a user of the data arrival. The exemplary data flow is similar to that shown and described with respect to FIG. 4, accordingly only differences will be discussed in detail.

In this example, a data set resides with data source 520 for potential transfer to device 510. The data set may be parsed into two or more data segments. A first data segment, of reduced size compared to the data set, is transferred to device 510 via transfer 550. The reduced size data segment may include an email with an associated attachment removed, a truncated or otherwise reduced size data segment associated with the full data set, or both. In one example, the data set may include a media object and the first segment may include a portion of or associated with the media object, e.g., the first few seconds of a video file or music file, a low resolution version of an image or video file, or may include data associated with the data set, such as a description of the data set, e.g., based on metadata, including, e.g., the source of the data, date/time created, sender information, author, or the like.

The user may request the data set associated with the reduced size data set at 556. In some examples, the method and system may include an option for the user to select a portion of or all of the data set to be transferred. For example, a user may initially receive a low resolution image file via transfer 550 and select from two or more relatively high resolution image file versions available from data source 520 for subsequent delivery to device 510. In another example, a user may initially receive a small audio file relating to a song via transfer 550 and select from transfer of the entire song or transfer of an entire album associated with the audio file. Various other schemes are possible for various types of data files and applications.

Additionally, in one example, device 510 may notify the user that the additional data will be retrieved via notification 554. Notification 554 may further indicate another notice will be generated upon arrival of the data to device 510. In one example, notification 554 may also include a time estimate for retrieval of the data, e.g., based on an estimated or known data size and communication speed between device 510 and data source 520.

The additional data requested at 556 from data source 520 is fetched from source 520 via transfer 558. As previously described, the data is fetched asynchronously in the background of device Y10. In this example, after the data is fetched and available on device 510, a notification 560 is generated to indicate to the user that the additional data associated with the first data segment is available. The notification may take any form, and include, for example, a separate email message, an SMS message, icon on the display of device 510, a ring tone, or the like. The user may then access the additional data via device 510 as previously described.

Although the present invention has been described in connection with various examples and aspects, it is not intended to be limited to the specific form set forth herein. Rather, the scope of the present invention is limited only by the claims. Additionally, although a feature may appear to be described in connection with a particular example or aspect, one skilled in the art would recognize that various features of the described examples and aspects may be combined in accordance with the invention. Moreover, aspects of the invention describe in connection with an example or aspect may stand alone as an invention.

Moreover, particular examples have been discussed and how these examples are thought to address certain disadvantages in related art. This discussion is not meant, however, to restrict the various examples to methods and/or systems that actually address or solve the disadvantages.

What is claimed is:

1. A device comprising a memory, a display, a communication interface, and a processor, the device comprising logic operable to:
receive a data segment from a remote location, the data segment associated with additional data located remotely;
receive a request for the additional data;
initiate a fetch of the additional data, wherein the additional data is fetched in the background of the device; and
initiate a notification after initiating the fetch of the additional data that the additional data has been received.

2. The device of claim 1, wherein the fetch comprises an asynchronous fetch of the additional data.

3. The device of claim 1, wherein the data segment comprises a portion of an email message and the additional data includes additional data of the email message.

4. The device of claim 3, wherein the data segment includes an ASCII email message, and the additional data includes an HTML or RTF email message.

5. The device of claim 1, wherein the data segment comprises at least a portion of an email message and the additional data includes a media object associated with the email message.

6. The device of claim 1, wherein the data segment comprises at least a portion of an email message and the additional data includes an attachment associated with the email message.

7. The device of claim 1, wherein the data segment comprises a first portion of a media object and the additional data comprises the first portion of the media object and the additional data.

8. The device of claim 1, wherein the data segment comprises a first portion of a media object and the additional data comprises a data set including the data segment.

9. The device of claim 1, further comprising logic operable to initiate a notification after receiving the request for the data that the additional data will be fetched.

10. The device of claim 1, wherein the notification comprises displaying the additional data.

11. The device of claim 1, wherein the device comprises a mobile device.

12. A system for coordinating the transfer of data to a device, the system comprising logic operable to:
parse a data set into at least a first data segment and second data segment;
initiate a transfer of the first data segment to a remote device;
receive a request for the second data segment from the remote device; and
initiate a transfer of the second data segment.

13. The system of claim 12, wherein the first data segment comprises an email message, and the second data segment comprises an attachment.

14. The system of claim 12, wherein the first data segment comprises an email message, and the second data segment comprises a media object.

15. The system of claim 12, wherein the first data segment comprises a portion of an email message and the second data segment includes additional data of the email message.

16. The system of claim 12, wherein the first data segment includes an ASCII email message, and the additional data segment includes an HTML document.

17. The system of claim 12, wherein the first data segment includes an ASCII email message, and the additional data segment includes an RTF email message.

18. The system of claim 12, further comprising logic operable to initiate a notification after initiating the transfer of the second data segment that the second data segment has been transferred to the remote device.

19. The system of claim 12, wherein the second data segment is transferred to the remote device.

20. The system of claim 12, wherein the second data segment is transferred to a storage location and further comprising logic operable to alert the remote device of the location of the second data segment for retrieval.

21. The system of claim 12, further including transcoding the first data segment before initiating the transfer of the first data segment to the remote device.

22. The system of claim 12, further including transcoding the second data segment before initiating the transfer of the second data segment.
